(19) United States
(12) Patent Application Publication
(10) Pub. No.: US 2011/0175986 A1
(43) Pub. Date: Jul. 21, 2011

(54) METHOD AND DEVICE FOR BIOMETRIC IDENTIFICATION OF PERSONS ACCORDING TO THE HAND GEOMETRY

(75) Inventors: Martin Drahansky, Brno (CZ); Filip Orsag, Brno (CZ); Radim Dvorak, Brno (CZ)

(73) Assignee: Brno University of Technology, Brno (CZ)

(21) Appl. No.: 12/737,515

(22) PCT Filed: Jul. 15, 2009
(86) PCT No.: PCT/CZ2009/000092

§ 371 Date: Jan. 20, 2011

(30) Foreign Application Priority Data
Jul. 21, 2008 (CZ) PV2008-453

(51) Int. Cl. H04N 13/02; G06K 9/00

(52) U.S. Cl. 348/47; 382/115; 348/E13.074

(57) ABSTRACT

The invention relates to a method of bio-metric identification of persons according to the hand, by which the shape of the hand is scanned, evaluated and compared with the database of hand shapes, whereas the three-dimensional (3D) shape of the hand is scanned, this is analysed and a three-dimensional (3D) model of the hand is created, which is compared with the database of three-dimensional (3D) models of hand. The invention also relates to a device for biometric identification of persons according to the hand comprising a pad and a scanning device (2) coupled with a control and evaluating unit, while the pad comprises a positioning depression (1) in the shape of a hand, while the positioning depression (1) is whole situated in the field of view of the scanning device (2) and in the area of impact of radiation from a source (21) of light.

### TECHNICAL FIELD

The invention relates to a method of biometric identification of persons according to the hand, by which the shape of the hand is scanned, evaluated and compared with the database of hand shapes.

The invention also relates to a device for biometric identification of persons according to the hand comprising a pad and a scanning device coupled with a control and evaluating unit.

### BACKGROUND ART

The biometric security systems are becoming to be widely spread nowadays. Their success in the market is conditioned by many factors, among others the most decisive is e.g. the entropy factor (i.e. how great number of users the system is able to distinguish one from another) and also the willingness of users to use the given biometric identification system.

The only system available in the market under a commercial name “HandKey” or “HandPunch” is described in EP 0 132 665 B1 and in EP 0 209 317 B1, and also on http://recognitionsystems.schlage.com/products/product.php?id=2. This system is based on scanning and recognition of two-dimensional (2D) contour of a human hand, while the system works with 16 specifications/dimensions. At this solution the hand is inserted into the device and positioned on a board with hold-down pins, which serve for a proper positioning of fingers, so that they are always equally distanced and the hand is inserted into the measuring chamber correctly. Positioning of these hold-down pins is also a subject of a patent. The hand is primarily scanned from above, while the hand contour is decisive, that means its 2D shape in the plane of the board on which the hand is being positioned. In this direction of view the system acquires 14 values as the specifications about 2D hand contour. Another 2 specifications presents 2D image of the hand from the lateral side, where in the device there is positioned on the inner lateral side a mirror, which projects this side 2D image of the hand into the camera positioned on the top. The device uses only 1 camera. In the view from above, 14 dimensions are determined on the monitored hand, such as the length of fingers, the width of fingers and the width of back of the hand, and in the view from the side on the monitored hand 2 specifications are determined, like the height of fingers and height of the back of the hand. In this way obtained 16 dimensions are scored and compared with the database by which the biometric identification of person is performed.

The main disadvantage of this system is a low level of the biometric entropy information obtained by this system, which is therefore not able to achieve the necessary certainty in distinguishing the proper person without confusion with another person. In principle the quantity of measured features of the hand is insufficient to achieve the required low probability that for two various persons the same data will be acquired, through which these two various persons would be considered by the system to be one person.

The goal of the invention is to improve especially the distinguishing abilities and accuracy of biometric identification of persons based on monitoring the hand.

### PRINCIPLE OF THE INVENTION

The goal of the invention has been achieved through a method of biometric identification of persons, whose principle consists in that a three-dimensional (3D) shape of a hand is scanned, this is analysed and a three-dimensional model of the hand is created, which is compared with a database of three-dimensional models of hands.

Through scanning of the 3D shape of the hand an important increasing of biometric entropy is achieved, because the whole surface of the hand is taken, including its height arrangement, recesses, projections, etc. By this method even anomalies of the hand, which are not applicable in the 2D model, may be considered.

The principle of the device for biometric identification of persons according to the hand comprising a pad, source of light and at least one camera is that the pad comprises the positioning depression in the shape of a hand, while the positioning depression is whole situated in the field of view of a scanning device and in the area of impact of radiation from the source of light, while the scanning device is connected with a control and evaluating unit.

The advantageous embodiments of invention are subject of the dependent claims and they are also shown in the description of examples of embodiments of the invention.

### DESCRIPTION OF THE DRAWING

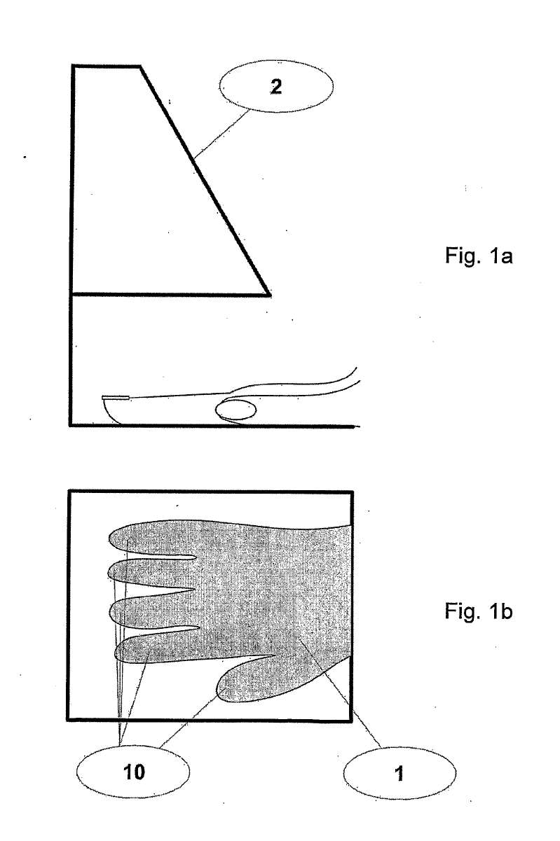

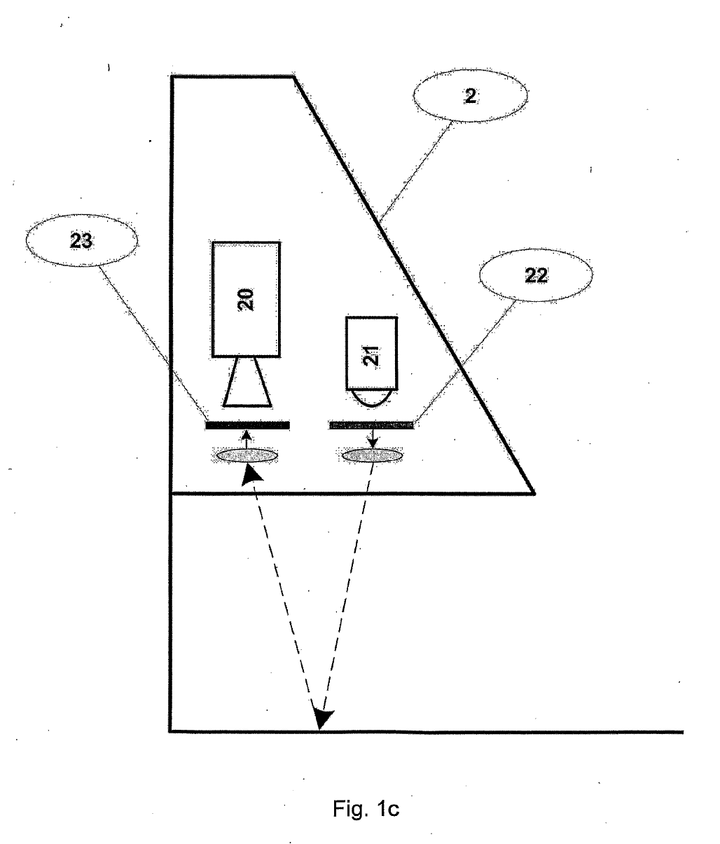

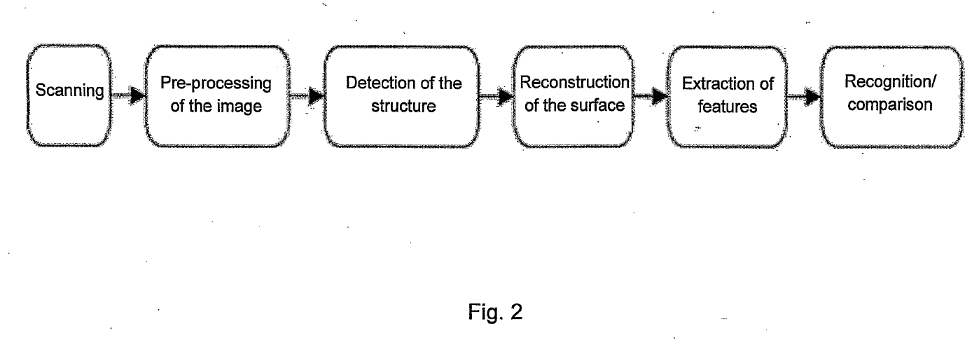

The invention is schematically represented on the drawing, where the FIG. 1a shows a side view to the device for biometric identification of persons with inserted hand, the FIG. 1b a ground plan view to the pad with the positioning depression, the FIG. 1c arrangement of elements of the device for biometric identification of persons, the FIG. 2 flow diagram of biometric identification of persons according to the invention.

### EXAMPLES OF EMBODIMENT

The method of biometric identification of persons according to the invention is based on the principle of recognition of three-dimensional (3D) shape of the hand, through which significantly higher distinguishing range is achieved, what may be utilised for a reliable identification of significantly larger group of persons than by the solution known from the background art.

Biometric identification according to the invention is performed so that on the pad, which comprises the positioning depression 1 in the shape of a hand, as it is represented in the FIGS. 1a, 1b, the whole hand, i.e. fingers as well as palm is placed. The positioning depression 1 comprises for individual fingers the positioning grooves 10, which are created in a suitable manner, e.g. with skew walls, i.e. in cross-section they are approximately a triangle, so that the fingers are automatically directed into the centre of the positioning grooves 10, through which the possibility of unwilling incorrect placing of the hand is limited, with exception of intended placing of the hand beside the grooves, which will lead to rejection in the decision-making process on biometric identification. Thanks to positioning the hand into the positioning depression 1 the hand is sufficiently fixed in stable and relatively exactly given position, this including the position of fingers, which are by the same person always in the same position with a certain tolerance. Moreover the loss of data caused by the hold-down pins, like the cutting-off the shape of fingers in an immediate vicinity of these pins etc., as it is at the background art, does not occur. In a not represented example of embodiment the hand is fixed on the pad by means of another suitable manner.

The hand placed on the pad is scanned by the scanning device 2 and its 3D image is obtained, more exactly the 3D image of its surface is obtained.

As represented in the FIG. 1c, the 3D image of the hand is obtained by a scanning device 2 comprising a camera 20 and a source 21 of light. In front of the source 21 of light, there is positioned the raster plate 22, that comprises bellow described system of lines, which is projected on the hand being scanned. The applied light is the radiation of light visible or invisible for the human eye. In the represented example of embodiment in front of the camera objective 20 there is positioned an optical filter 23 for radiation of light of a suitable wave length, so that a better visualisation of lines projected by the raster plate 22 on the hand is obtained. Between the source 21 of light and the raster plate 22 or in front of the raster plate 22, there may be positioned an optical mean for adjustment of the light beam in such a manner so that the projected raster (grid, lines, etc.) is sharp or has other specific properties suitable for further processing. Equivalently, the optical means may be assigned also to the camera 20-filter 23 system.

The camera 20 exemplary has the CCD scanning element, in another example of embodiment it has another type of scanning element, e.g. the CMOS etc. In the represented example of embodiment as a source 21 of light, the light-emitting diode (LED) is applied, while in a not represented example of embodiment as a source 21 of light the OLED source, the laser source, etc. is applied. The raster plate 22 is according to one embodiment a part of the source 21 of light, e.g. it is performed through direct etching of projected lines to the laser diode etc., or it is formed by an independent element. The raster plate 22 has a suitable shape of its lines which need not to be right-angled, the lines may be performed in the form of right-angled grid, non right-angled grid, linear lines, mutually crossing lines, etc. In a not represented example of embodiment the raster plate 22 is moveable and contains a single line, which moves above the whole hand and so gradually displays individual cross profiles of the monitored hand, consequently in a mathematical way from individual cross profiles the 3D profile of the whole hand is composed.

According to a not represented example of embodiment the 3D image of the hand placed on the pad is obtained through stereoscopic scanning by mean of two cameras.

Activity of the device and evaluation is performed by a not represented control and evaluating unit (e.g. computer), which is connected with the scanning device 2.

Algorithm of processing of the 3D shape of the hand is schematically represented in the FIG. 2. The principle is based on the evaluation method of curvature of the projected light or pattern (raster) on the 3D surface of the object (e.g. the hand) and the backward reconstruction of original shape from this information. After scanning (digitalisation) of the hand image a 3D hand shape is processed by the software application, while the representation of the 3D hand shape is expressed using the network model, vector model or the raster representation (let us call this representation the pattern of the hand). In the represented examples of embodiment the recognition and the consequent identification is performed from the back of the hand, in not represented examples of embodiment the recognition and the consequent identification is performed from the palm of hand or combination of both sides. For recognition from the palm of hand the positioning depression 1 in the pad is adequately modified.

In the first step scanning of the 3D geometry of the hand is performed as it is obvious from the previous description. After then a pre-processing of the image follows in the scope of which usual graphic operations with the image are performed like improving the image quality, adjustment of contrast/brightness, focusing/defocusing, adaptive thresholding etc. After pre-processing of image a detection of the structure follows, which is further followed by reconstruction of the surface and creation of the 3D shape of the hand (pattern). These steps as such are composed of more sub-steps, whose goal is to find the important points of the structure out of which the 3D surface may be reconstructed. Some of these important points are transferred into features, which create the hand pattern. This is followed by extraction of features, which may be also extracted from other information, such as the mutual position of points, from the course of curves between the points, etc. In case of raster information (texture) it may be a description of structure of the texture. After then the step of recognition/comparison follows, when the obtained 3D image of the hand is compared with the database of 3D images (patterns) of hand of registered persons. Recognition is based on two basic steps. The first is a rough alignment (comparing the rotation and translation between the hand pattern and the just obtained 3D hand shape). The second is a fine alignment, in the scope of which the concordance of obtained 3D hand image with the pre-defined tolerance limit (so called tolerance boxes) is determined.

The result of the whole process of recognition/comparison is determining of matching rate (so called comparison score), which corresponds to percentage matching of the pattern with the newly scanned/obtained 3D hand image. The higher is the matching rate, the higher is the probability that both images of 3D hand shape originate from the same user. The threshold for decision, whether the given value of matching rate shall be considered as a value corresponding to the matching depends on decision of system administrator, i.e. on strictness of requirement as to exact identification. Too low value of the threshold may lead to acceptance of matching of two compared patterns that do not originate from the same person, on the contrary too high value of the threshold results to too high number of non-conformities (rejections), i.e. cases, when the obtained 3D images being of the same person are considered to be different.

### LIST OF REFERENTIAL MARKINGS

1 positioning depression
10 positioning groove
2 scanning device
20 camera
21 source of light
22 raster plate
23 optical filter

1. A method of biometric identification of persons according to the hand, by which the shape of the hand is scanned, evaluated and compared with the database of hand shapes, characterised in that the three-dimensional (3D) shape of the hand is scanned, this is analysed and a three-dimensional (3D) model of the hand is created, which is compared with a database of three-dimensional (3D) models of hand.

2. The method according to the claim 1, characterised in that the three-dimensional (3D) shape of the hand is scanned by one camera, while a raster is projected on the hand.

3. The method according to the claim 1, characterised in that the three-dimensional (3D) shape of the hand is obtained through stereoscopic scanning by two cameras.

4. The method according to any of the claims 1 to 3, characterised in that the scanning is performed on the back of the hand.

5. The method according to any of the claims 1 to 3, characterised in that the scanning is performed on palm of the hand.

6. A device for biometric identification of persons according to the hand comprising a pad, a source of light and a scanning device coupled with a control and evaluating unit, characterised in that the pad comprises a positioning depression (1) in the shape of a hand, while the positioning depression (1) is whole situated in the field of view of the scanning device (2) and in the area of impact of radiation from the source (21) of light.

7. The device according to the claim 6, characterised in that the scanning device (2) comprises the camera (20) and the source (21) of light, while to the source (21) of light is assigned a raster plate (22).

8. The device according to the claim 7, characterised in that to the camera (20) is assigned an optical filter (23).

9. The device according to the claim 6, characterised in that the scanning device (2) comprises a pair of cameras arranged for stereoscopic scanning and further it comprises the source of light.
